(19) United States
(12) Patent Application Publication
(10) Pub. No.: US 2021/0299798 A1
(43) Pub. Date: Sep. 30, 2021

(54) WELD METAL DEPOSIT AND METAL POWDER CORED WELDING WIRE FOR PRODUCING A WELD METAL DEPOSIT

(71) Applicant: voestalpine Bohler Welding Austria GmbH, Kapfenberg (AT)

(72) Inventor: Hannes PAHR, Leoben (AT)

(21) Appl. No.: 17/212,461

(22) Filed: Mar. 25, 2021

(30) Foreign Application Priority Data
Mar. 26, 2020 (EP) 20020137.4

(51) Int. Cl. B23K 35/30; C22C 38/52; C22C 38/50; C22C 38/46; C22C 38/44; C22C 38/06; C22C 38/04; C22C 38/02; B23K 35/02

(52) U.S. Cl. CPC B23K 35/3066; C22C 38/52; C22C 38/50; C22C 38/46; B23K 35/0261; C22C 38/06; C22C 38/04; C22C 38/02; C22C 38/44

(57) ABSTRACT

The invention relates to a weld metal deposit having the following chemical composition:
C: 0.08-0.10 wt %
Mn: 1.30-2.00 wt %
Si: 0.35-0.60 wt %
Cr: 0.60-0.80 wt %
Ni: 2.50-3.00 wt %
Mo: 0.30-0.80 wt %
V: 0.20-0.30 wt %
   and optionally further components, in particular:
Co: ≤0.02 wt %
Ti: 0.01-0.02 wt %
Al: ≤0.010 wt %,
   Balance: iron as well as unavoidable impurities.

The invention relates to a weld metal deposit and a metal powder cored welding wire comprising a filler powder and a sheath enclosing the filler powder for the production of a weld metal deposit in an arc welding process.

In industrial applications as well as in the vehicle and construction industry, there is a need for weight reduction, so that various lightweight construction principles, such as lightweight construction and lightweight materials, are increasingly being implemented. In lightweight construction, attempts are made to reduce weight by means of constructive measures, in particular the aim being to utilize the material volume as uniformly as possible. Lightweight construction is based on replacing the original material of a component with another material with higher specific properties. Compared to conventional steel grades, high-strength steels usually allow smaller wall thicknesses with the same component properties. The use of steels with higher strength makes it possible to reduce the thickness of the parts without sacrificing safety and functional requirements. High-strength steels have a yield strength Rₑ of more than 355 N/mm².

In order to be able to make the best possible use of the advantages of such high-strength steels, it is advantageous in welded constructions to also optimize the strength of the welded joint. In particular, the welding of high-strength steels requires the use of a suitable filler material. The filler material flows together with the melted base material during welding and thus contributes to the formation of the weld seam. The filler material largely determines the properties of the weld seam, such as strength and deformability.

When welding with cored wire electrodes, the mechanical quality values of the weld metal deposit can be strongly influenced by the powder filling. In the case of cored wire electrodes, depending on the type of gas shielding, a distinction is made between gas-shielded cored wire electrodes, which are welded with shielding gas, and self-shielding cored wire electrodes, which generate their shielding gas from elements of the filling themselves by the arc. In the case of gas-shielded cored wire electrodes, a distinction is made between metal powder cored wires and rutile and/or basic slag-carrying cored wire electrodes.

The filling of the metal powder cored wires consists essentially of iron powder, alloying elements and arc-stabilizing elements. Metal powder cored wires do not form slag, so the surface of the weld seam is free of slag; depending on the shielding gas and the base material, only isolated silicate and oxide islands are possible on the surface of the weld bead.

The aim of the invention is to improve a weld metal deposit in such a way that it has the minimum yield strength necessary for welding high-strength steels and at the same time a high absorbed impact energy.

To achieve this object, the invention provides, according to a first aspect, a weld metal deposit which has the following chemical composition:
C: 0.08-0.10 wt %
Mn: 1.30-2.00 wt %
Si: 0.35-0.60 wt %
Cr: 0.60-0.80 wt %
Ni: 2.50-3.00 wt %
Mo: 0.30-0.80 wt %
V: 0.20-0.30 wt %
   and optionally further components, in particular:
Co: ≤0.02 wt %
Ti: 0.01-0.02 wt %
Al: ≤0:010 wt %,
   Balance: iron as well as unavoidable impurities.

According to a preferred embodiment, the weld metal deposit has the following chemical composition:
C: 0.080-0.095 wt %
Mn: 1.40-1.50 wt %
Si: 0.35-0.55 wt %
Cr: 0.60-0.80 wt %
Ni: 2.50-3.00 wt %
Mo: 0.30-0.60 wt %
V: 0.20-0.25 wt %
   and optionally further components, in particular:
Co: ≤0.02 wt %
Ti: 0.007-0.018 wt %
Al: ≤0.007 wt %,
   Balance: iron as well as unavoidable impurities.

The invention is based on an investigation of the influence of the alloying elements on the mechanical properties of the pure weld metal deposit. An alloy design could be found with which more energy-efficient components with lower weight and even higher load capacity can be constructed.

In addition, the relationship between the microstructure and the resulting mechanical properties of the entire weld metal deposit was examined in detail. It has been shown, surprisingly, that the strength is significantly higher than with conventional alloy compositions due to a combination of closely selected quantity ranges of the individual alloy elements. In particular, it has been found that the strength of the alloy composition according to the invention increases significantly due to a relatively high vanadium content of more than 0.20% by weight. In particular, a cluster formation of vanadium was observed, which is apparently responsible for the significant increase in strength. With vanadium contents of more than 0.30% by weight, however, the notched impact strength drops sharply. In addition, it has been found that a fine chaotic martensitic microstructure is desirable in order to achieve the required toughness.

Numerical simulations showed reasonable agreement with the mechanical tests. The alloy concept according to the invention also has excellent welding properties with regard to droplet detachment and arc stability.

In addition, tests with butt joint welds with suitable base material of the same type have shown that the high strength values and toughness properties can be achieved using different cooling rates. In particular, it was found that the cooling rates can be varied with t8/5 times between 5 and 25 seconds without significantly changing the mechanical properties of the weld metal deposit. The t8/5 time indicates the time that is required during the cooling of a weld bead and its heat-affected zone to pass through the temperature range from 800° C. to 500° C.

A weld metal deposit with the following chemical composition is preferred:
C: 0.080-0.090 wt %
Mn: 1.40-1.50 wt %
Si: 0.40-0.50 wt %
Cr: 0.60-0.70 wt %
Ni: 2.70-3.00 wt %
Mo: 0.50-0.60 wt %
V: 0.20-0.25 wt %
   and optionally further components, in particular:
Co: ≤0.02 wt %
Ti: 0.007-0.018 wt %
Al: ≤0.007 wt %,
   Balance: iron as well as unavoidable impurities.

With regard to the vanadium content, it is preferably provided that the upper limit value of vanadium is 0.30% by weight or 0.29% by weight or 0.28% by weight or 0.27% by weight.

With regard to the vanadium content, it is furthermore preferably provided that the lower limit value of vanadium is 0.20% by weight or 0.21% by weight or 0.22% by weight or 0.23% by weight or 0.24% by weight.

In the context of the invention, the following ranges for the vanadium content are therefore possible (% by weight):

0.20-0.30, 0.20-0.29, 0.20-0.28, 0.20-0.27,
0.21-0.30, 0.21-0.29, 0.21-0.28, 0.21-0.27,
0.22-0.30, 0.22-0.29, 0.22-0.28, 0.22-0.27,
0.23-0.30, 0.23-0.29, 0.23-0.28, 0.23-0.27,
0.24-0.30, 0.24-0.29, 0.24-0.28, 0.24-0.27.

The content of other components is preferably limited as follows:
Nb: ≤0.002 wt %
N: ≤0.05 wt %
O: ≤0.05 wt %
P: ≤0.012 wt %
S: ≤0.010 wt %
Cu: ≤0.3 wt %

It is preferably provided that the weld metal deposit has a tensile strength Rm of greater than 1100 MPa, particularly preferably greater than 1150 MPa (measured in a tensile test according to DIN EN ISO 6892-1:2017-02).

The weld metal deposit preferably has an offset yield strength Rp0.2 of greater than 1100 MPa. The offset yield strength Rp0.2 is the 0.2% yield point, which corresponds to the uniaxial mechanical stress at which the permanent elongation based on the initial length of the specimen is exactly 0.2% after unloading, measured in a tensile test according to DIN EN ISO 6892-1:2017-02.

Furthermore, it is preferably provided that the weld metal deposit has an absorbed impact energy of greater than 35 J, particularly preferably greater than 40 J, at +20° C.

It is preferably provided that the weld metal deposit has an absorbed impact energy of greater than 35 J, particularly preferably greater than 40 J, at −20° C.

The absorbed impact energy in this case is determined in a notched-bar impact bending test according to DIN EN ISO 148-1.

In order to ensure that both the tensile strength and the notched impact strength of the weld metal deposit exceed corresponding minimum values, it is preferably provided that the weld metal deposit has a product of the tensile strength Rm and the absorbed impact energy of >39500 MPa·J, preferably >50000 MPa·J.

It is preferably provided that the weld metal deposit has an elongation at break A5 of greater than 10%, preferably greater than 12%. The elongation at break is determined in a tensile test in accordance with DIN EN ISO 6892-1:2017-02, the ratio of the initial gauge length L₀ to the initial diameter d₀ of the sample being 5.

The weld metal deposit preferably has a martensitic structure.

According to a second aspect, the invention provides a metal powder cored welding wire, comprising a filler powder and a sheath enclosing the filler powder for producing a weld metal deposit in an arc welding process, the metal powder cored welding wire being designed to form a weld metal deposit of the invention.

It is preferably provided that the filler powder has arc stabilizers in order to further improve the welding properties of the cored wire electrode.

Furthermore, it is preferably provided that the weight of the filler powder is between 10 and 30% of the weight of the cored wire electrode. This value is also referred to as filling ratio.

In order to ensure that the filling powder is held securely in the sheath, it is preferably provided that the sheath is formed by a butt-butted or folded or welded band. This enables the simple and efficient production of the sheath by weighing the filling powder into a shaped strip and subsequently closing the latter. In principle, the metal powder cored welding wire can be manufactured, in three different ways: butt-butted or folded manufacturing route; closed form manufacturing route or welded manufacturing route (e.g. laser welding or high-frequency welding). In the closed form, discontinuous manufacturing process, the powder is introduced into an already closed tube by shaking.

In the following, the invention will be explained in more detail by way of exemplary embodiments.

The testing of the mechanical-technological properties of the pure weld metal deposit was carried out in accordance with EN ISO 15792-1 edition: 2019 Nov. 15. The metal powder cored welding wire can have an outer diameter of 0.9 mm to 2.4 mm.

The following welding parameters were used:
Welding voltage: 23-29 V
Welding wire feeding: 7-10 m/min

The metal powder cored welding wire was welded at direct current at the positive pole at 24V voltage under a shielding gas atmosphere.

The following material properties of the pure weld metal deposit were measured, i.e. without the influence of the base material, for example in the heat-affected zone. The measurements of the chemical composition were carried out on a cylinder made of several layers of pure weld metal deposit.

The chemical analysis of the pure weld metal deposit was determined by means of a spark spectrometer and the data obtained in this way were regularly checked with the wet chemical analyzes of a certified laboratory.

The tests on which the exemplary embodiments are based were carried out in order to obtain a metal powder cored welding wire which, after processing in the pure weld metal deposit, has a offset yield strength Rp0.2 of at least 1100 MPa, an elongation at break of at least 10% and at the same time sufficient toughness values, in particular a high absorbed impact energy of at least 35 J at −20° C. The required minimum absorbed impact energy of 35 J at −20° C. in the pure weld metal deposit is necessary in order to be able to use it in connection with a high-strength base material of the same type with a yield point >1100 MPa to achieve a minimum absorbed impact energy of 27 J. This applies to liquid-quenched and tempered or thermomechanically rolled steels.

### EXAMPLES 1-4

In Examples 1 to 4, a weld metal deposit with the alloy compositions given in Table 1 was obtained. The rest consists of iron as well as inevitable impurities.

TABLE 1

| | Expl. 1 | Expl. 2 | Expl. 3 | Expl. 4 |
|---|---|---|---|---|
| C [% by weight] | 0.09 | 0.08 | 0.07 | 0.06 |
| Si [% by weight] | 0.4 | 0.5 | 0.4 | 0.5 |
| Mn [% by weight] | 1.4 | 1.4 | 1.2 | 1.4 |
| Cr [% by weight] | 0.7 | 0.6 | 0.6 | 0.5 |
| Mo [% by weight] | 0.5 | 0.5 | 0.5 | 0.5 |
| Ni [% by weight] | 2.7 | 2.9 | 2.2 | 2.8 |
| Al [% by weight] | 0.006 | 0.005 | 0.005 | 0.005 |
| Co [% by weight] | 0.007 | 0.008 | 0.006 | 0.007 |
| Ti [% by weight] | 0.01 | 0.01 | 0.01 | 0.01 |
| V [% by weight] | 0.23 | 0.22 | 0.22 | 0.22 |
| Tensile strength Rm | 1197 | 1185 | 1062 | 1120 |
| [MPa] | | | | |
| Offset yield strength | 1135 | 1127 | 1024 | 1087 |
| Rp0.2 [MPa] | | | | |
| Elongation at break | 14.2 | 12.3 | 10.6 | 12.7 |
| A5 [%] | | | | |
| Absorbed impact energy | 58 | 57 | 51 | 54 |
| CV at +20° C. [J] | | | | |
| Absorbed impact energy | 50 | 50 | 41 | 48 |
| CV at −20° C. [J] | | | | |
| According to the | x | x | | |
| invention | | | | |

In Examples 1 and 2, the content of the individual alloy elements was in the ranges according to the invention:
C: 0.08-0.10 wt %
Mn: 1.30-2.0 wt %
Si: 0.35-0.60 wt %
Cr: 0.60-0.80 wt %
Ni: 2.50-3.00 wt %
Mo: 0.30-0.80 wt %
V: 0.20-0.30 wt %
Co: ≤0.02 wt %
Ti: 0.01-0.02 wt %
Al: ≤0.010 wt %,

The result was a tensile strength Rm and an offset yield strength Rp0.2 of at least 1100 MPa in each case. Furthermore, the elongation at break was over 10% and the absorbed impact energy was over 35 J both at +20° C. and at −20 C.

In Example 3, the carbon content, the nickel content and the manganese content were reduced below the respective quantity range according to the invention. This resulted in a reduced tensile strength Rm and a reduced offset yield strength Rp0.2, both of which were below the set limit value of 1100 MPa.

In Example 4, the carbon content and the chromium content were reduced below the respective quantity range according to the invention. This resulted in a reduced offset yield strength Rp0.2, which was below the set limit value of 1100 MPa.

### EXAMPLES 5-8

In Examples 5 to 8, a weld metal deposit with the alloy compositions given in Table 2 was obtained. The only difference between the examples is the vanadium content. The rest consists of iron as well as inevitable impurities.

TABLE 2

| | Expl. 5 | Expl. 6 | Expl. 7 | Expl. 8 | Expl. 9 |
|---|---|---|---|---|---|
| C [% by | 0.08-0.09 | 0.08-0.09 | 0.08-0.09 | 0.08-0.09 | 0.08-0.09 |
| weight] | | | | | |
| Si [% by | 0.5 | 0.5 | 0.5 | 0.5 | 0.5 |
| weight] | | | | | |
| Mn [% by | 1.4 | 1.4 | 1.4 | 1.4 | 1.4 |
| weight] | | | | | |
| Cr [% by | 0.7 | 0.7 | 0.7 | 0.7 | 0.7 |
| weight] | | | | | |
| Mo [% by | 0.7 | 0.7 | 0.7 | 0.7 | 0.7 |
| weight] | | | | | |
| Ni [% by | 2.9-3.0 | 2.9-3.0 | 2.9-3.0 | 2.9-3.0 | 2.9-3.0 |
| weight] | | | | | |
| Al [% by | 0.006 | 0.006 | 0.006 | 0.006 | 0.006 |
| weight] | | | | | |
| Co [% by | 0.007 | 0.007 | 0.007 | 0.007 | 0.007 |
| weight] | | | | | |
| Ti [% by | 0.01 | 0.01 | 0.01 | 0.01 | 0.01 |
| weight] | | | | | |
| V [% by | 0.18 | 0.20 | 0.25 | 0.28 | 0.33 |
| weight] | | | | | |
| According to | | x | x | x | |
| the invention | | | | | |

In Examples 6, 7 and 8 the V content is in the range of 0.20-0.30% by weight according to the invention. In the other examples, the V content is either below the range according to the invention (Example 1) or above (Examples 8 and 9).

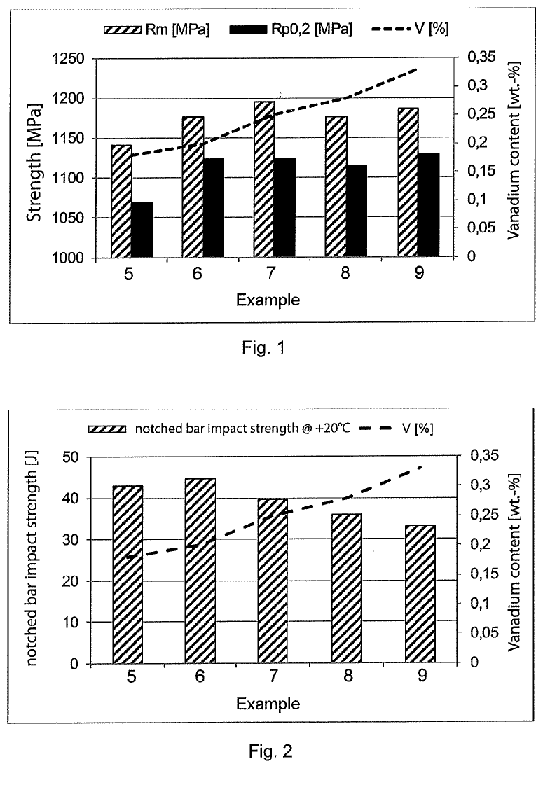

The measurement results for the tensile strength Rm and the offset yield strength Rp0.2 as a function of the vanadium content are shown in FIG. 1. FIG. 2 shows the notched impact strength as a function of the vanadium content.

FIG. 1 shows that the offset yield strength Rp0.2 exceeds the minimum value of 1100 MPa at a vanadium content of 0.20 or higher. However, with a vanadium content of 0.33% by weight (Example 9), the notched impact strength is no longer above the minimum value of 35 J and, in particular, is not high enough to achieve a minimum absorbed impact energy of 27 J in connection with a base material of the same type (see FIG. 2). Therefore, only Examples 6, 7 and 8 meet all the requirements and are therefore considered to be embodiments according to the invention.

1. A weld metal deposit comprising the following chemical composition:
C: 0.08-0.10 wt %
Mn: 1.30-2.00 wt %
Si: 0.35-0.60 wt %
Cr: 0.60-0.80 wt %
Ni: 2.50-3.00 wt %
Mo: 0.30-0.80 wt %
V: 0.20-0.30 wt %
optionally further comprising:
Co: ≤0.02 wt %
Ti: 0.01-0.02 wt %
Al: ≤0.010 wt %,
with the balance comprising iron and impurities.

2. A weld metal deposit comprising the following chemical composition:
C: 0.080-0.095 wt %
Mn: 1.40-1.50 wt %
Si: 0.35-0.55 wt %
Cr: 0.60-0.80 wt %
Ni: 2.50-3.00 wt %
Mo: 0.30-0.60 wt %
V: 0.20-0.25 wt %
optionally further comprising:
Co: ≤0.02 wt %
Ti: 0.007-0.018 wt %
Al: ≤0.007 wt %,
with the balance comprising iron and impurities.

3. The weld metal deposit according to claim 1, comprising the following chemical composition:
C: 0.080-0.090 wt %
Mn: 1.40-1.50 wt %
Si: 0.40-0.50 wt %
Cr: 0.60-0.70 wt %
Ni: 2.70-3.00 wt %
Mo: 0.50-0.60 wt %
V: 0.20-0.30 wt %, preferably 0.20-0.25 wt %
optionally further comprising:
Co: ≤0.02 wt %
Ti: 0.007-0.018 wt %
Al: ≤0.007 wt %,
with the balance comprising iron and impurities.

4. The weld metal deposit according to claim 1,
characterized in that the upper limit of vanadium is 0.30 wt % or 0.29 wt % or 0.28 wt % or 0.27 wt %.

5. The weld metal deposit according to claim 1,
characterized in that the lower limit of vanadium is 0.20 wt % or 0.21 wt % or 0.22 wt % or 0.23 wt % or 0.24 wt %.

6. The weld metal deposit according to claim 1, wherein the content of further components are limited as follows:
Nb: ≤0.002 wt %
N: ≤0.05 wt %
O: ≤0.05 wt %
P: ≤0.012 wt %
S: ≤0.010 wt %
Cu: ≤0.3 wt %

7. The weld metal deposit according to claim 1, characterized in that the weld metal deposit has a tensile strength Rm of greater than 1100 MPa, preferably greater than 1150 MPa.

8. The weld metal deposit according to claim 1, characterized in that the weld metal deposit has an offset yield strength Rp0.2 of greater than 1100 MPa.

9. The weld metal deposit according to claim 1, characterized in that the weld metal deposit has an absorbed impact energy of greater than 35 J, preferably greater than 40 J, at +20° C.

10. The weld metal deposit according to claim 1, characterized in that the weld metal deposit has an absorbed impact energy of greater than 35 J, preferably greater than 40 J, at −20° C.

11. The weld metal deposit according to claim 1, characterized in that the weld metal deposit has a product of tensile strength Rm and absorbed impact energy of >39500 MPa·J, preferably >50000 MPa·J.

12. The weld metal deposit according to claim 1, characterized in that the weld metal deposit has an elongation at break A5 of more than 10%, preferably more than 12%.

13. The metal powder cored welding wire comprising a filler powder and a sheath enclosing the filler powder for the production of a weld metal deposit in an arc welding process, characterized in that the metal powder cored welding wire is designed to form a weld metal deposit according to claim 1.

14. The metal powder cored welding wire according to claim 13, characterized in that the filler powder contains arc stabilizers.

15. The metal powder cored welding wire according to claim 13, characterized in that the weight of the filler powder makes up between 10 and 30% of the weight of the metal powder cored welding wire.
